(19) United States
(12) Patent Application Publication
(10) Pub. No.: US 2016/0099977 A1
(43) Pub. Date: Apr. 7, 2016

(54) METHOD OF UTILIZING TOKEN TO ENABLE ELECTRONIC DEVICES TO ACT SIMULTANEOUSLY WITH EACH OTHER

(71) Applicant: D-Link Corporation, Taipei City (TW)

(72) Inventors: Hsiu-Ju CHENG, Taipei City (TW); Ming-Han LIU, Taipei City (TW)

(73) Assignee: D-Link Corporation, Taipei City (TW)

(21) Appl. No.: 14/528,014

(22) Filed: Oct. 30, 2014

(30) Foreign Application Priority Data
Oct. 2, 2014 (TW) 103134362

(51) Int. Cl. H04L 29/06; H04L 12/24

(52) U.S. Cl. CPC H04L 65/1069; H04L 65/403; H04L 41/32

(57) ABSTRACT

The present invention is to provide a method enabling a first electronic device to execute steps of: connecting to a cloud server; establishing connection with a second electronic device to obtain a second device parameter stored in the second electronic device; transmitting a first device parameter stored therein and the second device parameter to the cloud server; receiving and storing a token generated by the cloud server, wherein the token is associated with management data stored in the cloud server when the cloud server determines that the first and second device parameters correspond to the management data; and transmitting the token to the second electronic device; such that the first and second electronic devices are stored with the same token, and the cloud server transmits a control instruction to the first and second electronic devices according to the tokens when the second electronic device is connected to the cloud server.

### FIELD OF THE INVENTION

The present disclosure generally relates to a method of managing electronic devices, more particularly, to a method of utilizing token to enable a plurality of electronic devices to act simultaneously with each other.

### BACKGROUND OF THE INVENTION

Recently, as various portable electronic devices become popular, people's lifestyles and habits have obvious change gradually. Currently, people can handle office routines without staying at office, buy movie ticket without going to movie theater, or watch pet at home by using internet camera even if being outdoors. It is obvious that an application area of the portable electronic device is very widely, so the portable electronic device is also called a smart device. In order to make the smart devices further go to people's life deeply and dig out more potential business opportunity, many device providers further make efforts in integrating the smart device with existing various electrical apparatuses, and expect to establish a comfortable life with remote control technology, such technology is called [symbol] smart family [symbol] .

According to investigations and analyses of the marketing research companies, a market of the smart family technology is estimated to have 17.74% in compound annual growth rate from year 2013 to year 2020, and the market scope in year 2020 will rise to 517.7 hundred million U.S. dollar. Therefore, the smart family is a mainstream development in the industry in the future. In order to implement ideal functions of the smart family, [symbol] wireless network [symbol] and [symbol] cloud management [symbol] are necessary basic technologies, it means that various electrical apparatuses must be provided with function of getting on the Internet, so that the user can remotely operate and manage the electrical apparatuses conveniently.

In order to enable the existing electrical apparatuses to link with the network for management, some companies developed a device called [symbol] smart power switch [symbol] . Please refer to FIG. 1, an exterior appearance of the smart power switch looks like a small adapter, and the smart power switch 1 has a male plug 11 and a female socket 12, and is further equipped with a network module for connecting to a network apparatus (such as a router) and further linking with the Internet. Therefore, the user just needs to plug the male plug 11 to a power source socket and connect the female socket 12 with the electrical apparatus (such as air conditioner, television or lamp), so that the user can remotely control the turning-on/off of the electrical apparatus by using the smart device (such as smart phone) to transmit a control signal via the Internet. In addition, smart power switch 1 can be installed other assistant function (such as a display screen 13 for displaying power consumption).

However, not every user has experience and knowledge about network configuration, so it is not easy to popularize the smart family if the configuration method is too inextricable and complicated. In addition, even if the user can control or manage all electrical apparatuses at home anytime and anywhere by the smart device carried with the user, but the operating actions which the user is required to do are not reduced, so the management is insufficiently convenient. For example, when the user wants to turn on the television, the lamp and the air conditioner at the same time, the user can remotely control by using the smart device without going to the front of the three electrical apparatuses, but the user still has to perform the operating actions for these three electrical apparatuses respectively. The user cannot turn on all electrical apparatuses by one-time operations.

In conclusion, there is a lack of a management method to provide the user to transmit corresponding instructions to all electrical apparatuses according to current demand or life habit. Therefore, what is need is a method which can be managed and operated more easily, and such method can provide the user to configure based upon his or her life habit and demand for facilitating to manage various electrical apparatuses in ambience.

### SUMMARY OF THE INVENTION

Because the existing service of smart family lacks a method to provide the user to configure and control various electrical apparatuses according to user's life habit and demand, the inventor bases many years research knowledge and industry experience, and performs test improvement for many times, to design a method of utilizing token to enable a plurality of electronic devices to act simultaneously with each other, in order to solve the above-mentioned problems.

Objective of the present disclosure is to provide a method of utilizing token to enable a plurality of electronic devices to act simultaneously with each other. The method is adapted in a management system which includes a cloud server, a network apparatus (such as a router), a first electronic device (such as a smart phone) and a second electronic device (such as a smart power switch). The cloud server is stored with a plurality of management data, and the first electronic device and the second electronic device are stored a first device parameter and a second device parameter (such as machine code during manufacturing), respectively. In the method, the first electronic device executes following steps of: connecting to the cloud server; establishing connection with the second electronic device to obtain the second device parameter stored in the second electronic device; transmitting the first device parameter and the second device parameter to the cloud server; on the cloud server, generating a token and associating the token with the management data when the cloud server determines that the first device parameter and the second device parameter correspond to the management data, respectively; receiving and storing the token returned by the cloud server, and transmitting the token to the second electronic device to enable the first electronic device and the second electronic device to store the same token, so that the cloud server respectively transmits a control instruction to the first electronic device and the second electronic device respectively according to the tokens when the second electronic device is connected to the cloud server.

Other objective of the present disclosure is that the first electronic device still stores a set of configuration data, so that the first electronic device can be linked to the network apparatus according to the configuration data. In addition, in the method, the first electronic device can transmit the configuration data to the second electronic device when the first electronic device determines that a connection between the second electronic device and the network apparatus is not established yet, so that the second electronic device can establish connection with the network apparatus according to the configuration data.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1 is a schematic view of a smart power switch in the prior art;

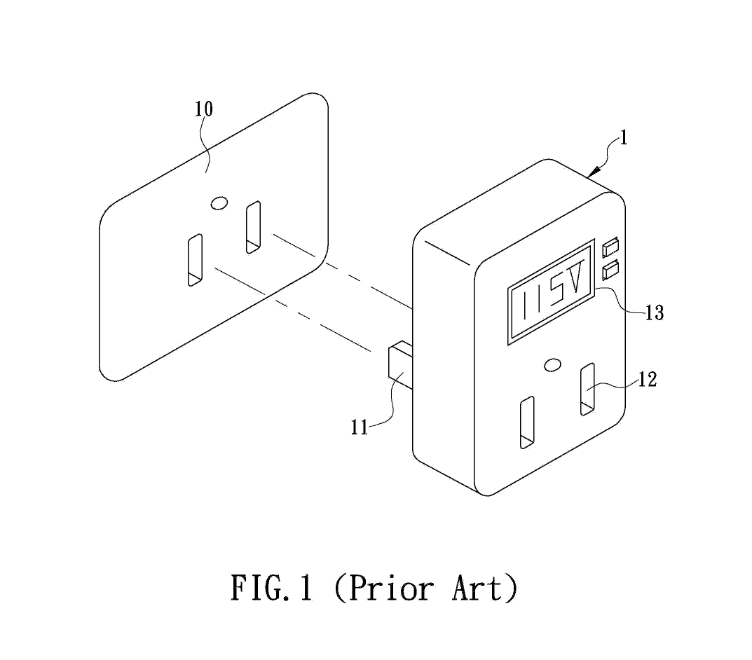

FIG. 2 is a schematic view of a management system in which the present disclosure is applied;

FIG. 3 is a schematic view of a flow of the present disclosure; and

FIG. 4 is a schematic view of other flow of the present disclosure;

### DETAILED DESCRIPTION OF THE PREFERRED EMBODIMENTS

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

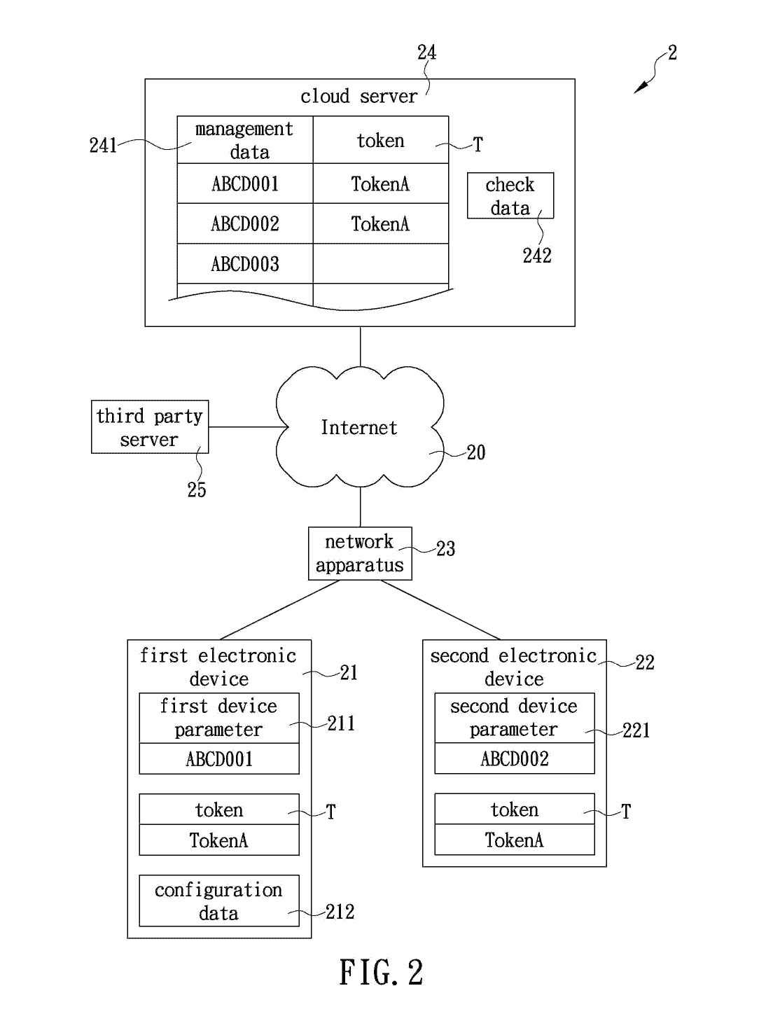

The present disclosure illustrates a method of utilizing a token to enable a plurality of electronic devices to act simultaneously with each other. Please refer to FIG. 2 which is a schematic view of the management system 2 in which the present disclosure is applied. The management system 2 includes a first electronic device 21 (such as a smart phone), a second electronic device 22 (such as a smart power switch), a network apparatus 23 (such as a router) and a cloud server 24. The first electronic device 21 and the second electronic device 22 are stored a first device parameter 211 and a second device parameter 221, respectively. The first device parameter 211 and the second device parameter 221 are machine codes preset in the electronic device 21 and 22 during manufacture; however, the present disclosure is not limited thereto.

Please refer to FIG. 2, the cloud server 24 is stored with a plurality of management data 241, and each of management data 241 and each of the device parameters 211 and 221 are the same type of the parameter data. In this exemplary embodiment, the device parameters 211 and 221 are the machine codes, so the manufacturer can store the machine codes in the cloud server 24 during manufacture for use as the management data, whereby the cloud server 24 can identify the electronic devices 21 and 22 according to the management data 241. In addition, in other exemplary embodiment, the device parameters 211 and 221, and the management data 241 can also be generated while the user registers the cloud server 24.

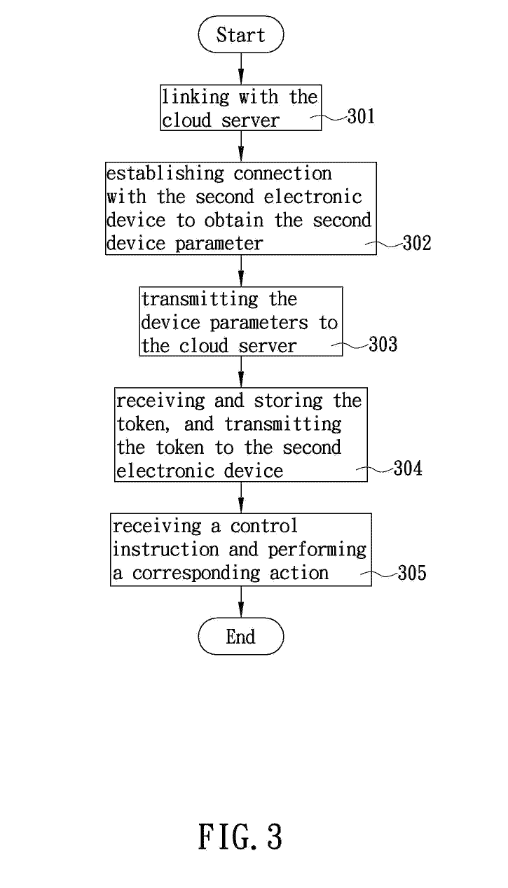

Please refer to FIG. 2 and FIG. 3. The method of the present disclosure mainly can store the same token in the electronic devices 21 and 22 both to facilitate managing operation, and the first electronic device 21 is operated to execute following steps.

In step (301), the first electronic device 21 is connected to the network apparatus 23, for linking with the Internet 20 via the network apparatus 23, so that the first electronic device 21 can further be linked with the cloud server 24. In other embodiment of the present disclosure, if the first electronic device 21 is the smart phone, the first electronic device 21 can also be linked to the cloud server 24 via its 2G/3G/4G communication networks.

In step (302), a connection is established between the first electronic device 21 and the second electronic device 22. The way of connection can utilize the local area network built by the network apparatus 23, functions of Bluetooth/infrared of the electronic devices 21 and 22, or a dedicated cell phone program APP installed in the electronic devices 21 and 22. After the connection is established, the first electronic device 21 can get the second device parameter 221 contained in the second electronic device 22.

In step (303), via the Internet 20 the first device parameter 211 and the second device parameter 221 are transmitted to the cloud server 24. The cloud server can search the management data 241 corresponding to the device parameters 211 and 221 to identify the electronic devices 21 and 22. Next, the cloud server 24 can generate a token T and associate the token T with each of the management data 241, and then return the token T to the first electronic device 21.

In step (304), the first electronic device 21 receives and stores the token T returned from the cloud server 24, and transmits the token T to the second electronic device 22, whereby the same token T is stored in the first electronic device 21 and the second electronic device 22 both.

In step (305), in the condition of the second electronic device 22 also linked with the cloud server 24 later, the cloud server 24 can transmit a control instruction to the first electronic device 21 and the second electronic device 22 according to the token, whereby each of the electronic devices 21 and 22 can execute the action corresponding to the control instruction received, for example, the action of turning on or turning off, or other function.

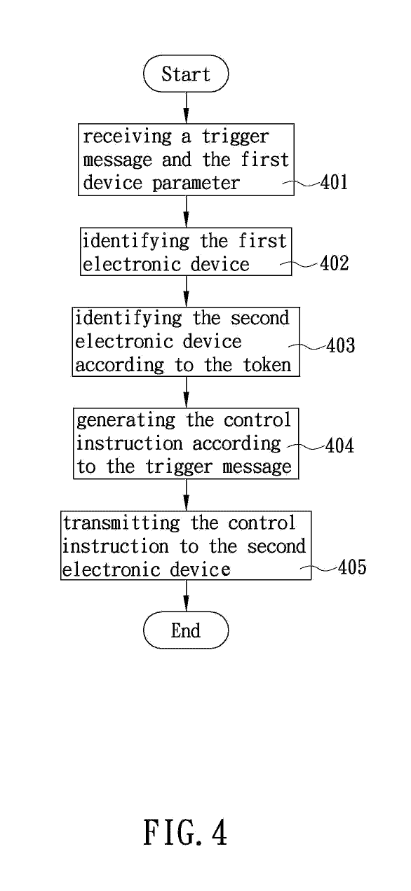

Therefore, according to the token T stored in the electronic devices 21 and 22, the cloud server 24 can transmit a control instruction to all of the electronic devices 21 and 22 having the same token T, so as to achieve the effect of acting simultaneously. Please refer to FIG. 2 and FIG. 4. The method of controlling simultaneous action is described in following paragraph, in view of the cloud server 24.

First, in step (401), the cloud server 24 receives a trigger message and the first device parameter 211 transmitted from the first electronic device 21 via the Internet 20.

In step (402), the cloud server 24 identifies the first electronic device 21 according to the first device parameter 211.

Similarly, in step (403), the cloud server 24 bases the token T to find the management data 241 corresponding to the token T, so as to identify the second electronic device 22.

In step (404), the cloud server 24 generates the control instruction according to the trigger message.

In step (405), the cloud server 24 transmits the control instruction to the second electronic device 22, to enable the second electronic device 22 to execute the corresponding action.

In the management system 2 shown in FIG. 2, only one second electronic device 22 is involved, however, the management system 2 can has a plurality of second electronic devices 22 in practical implementation. For example, the first electronic device 21 is the smart phone, and the second electronic device 22 can be multiple in number and are the television, the lamp and the air conditioner respectively. Therefore, the user just needs to transmit a trigger message for controlling all of the second electronic devices 22 to act simultaneously. Similarly, the first electronic device 21 can be the television, and the second electronic device 22 can be multiple in number and are the audio equipment and the air conditioner. The user can configure that the trigger message is generated actively while the first electronic device 21 [symbol] television [symbol] is turned on. Therefore, the user just needs to turn on the television, and then the cloud server 24 will automatically manage the audio equipment and the air conditioner to be turned on simultaneously.

However, the operation method of the management system 2 is not limited to the above-mentioned content. Please refer to FIG. 2. The cloud server 24 is still stored check data 242 which can include a time condition (such as five o'clock pm everyday), a weather condition (such as raining day), an electrical equipment condition (such as a determination whether [symbol] television [symbol] is at ON status) or an electric power condition (such as a determination whether a battery power of certain electrical equipment is too low), and correspond to the token T, so that the cloud server 24 generates the control instruction immediately when the cloud server 24 determines the current condition (i.e. time, weather or a status of electrical equipment) matching with the check data 242, and then transmits the control instruction to all of the electronic devices 21 and 22 having the same token T for further control.

When the check data is the time condition, the electrical equipment condition or the electric power condition, the electronic devices 21 and 22 can periodically transmit a check message to the cloud server 24 for determination of the cloud server 24. If the check data is the weather condition and the cloud server 24 cannot determine by itself, the cloud server 24 can periodically transmit the check data to a third party server 25 (such as a weather data server of Google), to enable the third party server 25 to determine whether the current condition matches the check data 242.

Moreover, the present disclosure further has a function of simplifying the network configuration. Please refer to FIG. 2. In this exemplary embodiment, the first electronic device 21 is still stored a set of configuration data 212, and the configuration data 212 at least include a service set identifier (SSID) and a password of the network apparatus 23. Therefore, the first electronic device 21 can be linked to the network apparatus 23 according to the configuration data 212. After the first electronic device 21 and the second electronic device 22 are linked with each other, if the first electronic device 21 determines that the second electronic device 22 does not correctly establish connection with the network apparatus 23, the first electronic device 21 can transmit the configuration data 212 to the second electronic device 22 in advance, to enable the second electronic device 22 to establish connection with the network apparatus 23 according to the configuration data 212. Therefore, the time and steps for user to set up the network configuration can be efficiently saved.

The way of the second electronic device 22 to link with the network apparatus 23 is not limited to the above-mentioned way, the user can also utilize the Wi-Fi protected setup-push button configuration (WPS) of the network apparatus 23 and the second electronic device 22, to enable the second electronic device 22 to link with the network apparatus 23.

In this exemplary embodiment, the cloud server 24 transmits the token T generated to the first electronic device 21, and the token T is then transmitted to the second electronic device 22 by the first electronic device 21. The cloud server 24 does not directly transmit the token T to the second electronic device 22 via the Internet 20 in consideration of the following situation. As the smart devices become popular, many countries pay more attention to protections for personal privacy and information security. The management system 2 shown in FIG. 2 is taken as example, before the second electronic device 22 is not linked with the Internet 20 yet, the user may not read and agree the terms of service provided by the cloud server 24 provider. In this case, it is easy to cause the data security of doubt and dispute if the data is directly transmitted between the second electronic device 22 and the cloud server 24.

In the present disclosure, apart from the consideration of data security, the method of utilizing the first electronic device 21 to transmit the token T to the second electronic device 22 can also simplify the configuration procedure for the user. In the management system 2, the user usually operate the smart phone carried for use as the first electronic devices 21, and utilizes the 2G/3G/4G communication networks to link with the cloud server 24 for registering a user account, or activating service, etc. In this case, the way of integrating the receipt and transmission of the token T in the first electronic device 21 is more convenient and more straightforward, so the user need not frequently operate the first electronic device 21 and the second electronic device 22, respectively.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A method of utilizing token to enable a plurality of electronic devices to act simultaneously with each other, applied in a management system which comprises a cloud server, a network apparatus, a first electronic device and at least one second electronic device, wherein the cloud server is stored with a plurality of management data, and the first electronic device and the second electronic device are stored with a first device parameter and a second device parameter, respectively, for enabling the first electronic device to execute steps of:
linking to the cloud server;
establishing connection with the second electronic device to obtain the second device parameter stored in the second electronic device;
transmitting the first device parameter and the second device parameter to the cloud server, wherein the cloud server generates a token and associates the token with the management data when the cloud server determines that the first device parameter and the second device parameter correspond to the plurality of management data, respectively; and
receiving and storing the token returned by the cloud server, and transmitting the token to the second electronic device to enable the first electronic device and the second electronic device to store the same token, so that the cloud server respectively transmits a control instruction to the first electronic device and the second electronic device according to the tokens when the first electronic device and the second electronic device are linked to the cloud server respectively.

2. The method as defined in claim 1 wherein, when the first electronic device and the second electronic device are linked to the cloud server, the method enables the cloud server to execute steps of:
receiving a trigger message and the first device parameter transmitted from the first electronic device;
identifying the first electronic device and the second electronic device having the same token according to the first device parameter;
generating the control instruction according to the trigger message; and
transmitting the control instruction to the second electronic device.

3. The method as defined in claim 1 wherein, the cloud server is further stored check data corresponding to the token, the method enables the cloud server to further execute step of:
generating the control instruction and transmitting the control instruction to the first electronic device and the second electronic device, under a condition of determining a current condition matching the check data.

4. The method as defined in claim 3, wherein the cloud server transmits the check data to a third party server periodically via an Internet, so as to enable the third party server to determine whether the current condition matches the check data.

5. The method as defined in claim 1, wherein, the first electronic device is stored with a set of configuration data, the first electronic device can be linked to the network apparatus according to the configuration data and, after the first electronic device and the second electronic device are linked, the first electronic device executes step of:
transmitting the configuration data to the second electronic device under a condition of determining the second electronic device not correctly establishing connection with the network apparatus, so as to enable the second electronic device to establish connection with the network apparatus according to the configuration data.

6. The method as defined in claim 2, wherein, the first electronic device is stored with a set of configuration data, the first electronic device can be linked to the network apparatus according to the configuration data and, after the first electronic device and the second electronic device are linked, the first electronic device executes step of:
transmitting the configuration data to the second electronic device under a condition of determining the second electronic device not correctly establishing connection with the network apparatus, so as to enable the second electronic device to establish connection with the network apparatus according to the configuration data.

7. The method as defined in claim 3, wherein, the first electronic device is stored with a set of configuration data, the first electronic device can be linked to the network apparatus according to the configuration data and, after the first electronic device and the second electronic device are linked, the first electronic device executes step of:
transmitting the configuration data to the second electronic device under a condition of determining the second electronic device not correctly establishing connection with the network apparatus, so as to enable the second electronic device to establish connection with the network apparatus according to the configuration data.

8. The method as defined in claim 4, wherein, the first electronic device is stored with a set of configuration data, the first electronic device can be linked to the network apparatus according to the configuration data and, after the first electronic device and the second electronic device are linked, the first electronic device executes step of:
transmitting the configuration data to the second electronic device under a condition of determining the second electronic device not correctly establishing connection with the network apparatus, so as to enable the second electronic device to establish connection with the network apparatus according to the configuration data.
